(19) United States
(12) Patent Application Publication
(10) Pub. No.: US 2023/0386206 A1
(43) Pub. Date: Nov. 30, 2023

(54) AUTOMATED SYSTEM AND METHOD FOR CLASSIFYING, RANKING AND HIGHLIGHTING CONCURRENT REAL TIME EVENTS

(71) Applicant: GRIIIP AUTOMOTIVE ENGINEERING LTD., Petach Tikva (IL)

(72) Inventors: Gilad AGAM, Givatayim (IL); Alon KRASNE, Kfar Yehoshua (IL); Tamir PLACHINSKY, Tel Mond (IL)

(73) Assignee: GRIIIP AUTOMOTIVE ENGINEERING LTD., Petach Tikva (IL)

(21) Appl. No.: 18/027,669

(22) PCT Filed: Sep. 23, 2021
(86) PCT No.: PCT/IL2021/051159

§ 371 Date: Mar. 22, 2023

Related U.S. Application Data
(60) Provisional application No. 63/081,965, filed on Sep. 23, 2020.
(60) Provisional application No. 63/172,240, filed on Apr. 8, 2021.

(51) Int. Cl. G06V 20/40; G06V 20/17; G06V 10/44

(52) U.S. Cl. CPC G06V 20/44; G06V 20/17; G06V 20/49; G06V 10/44; G06V 2201/07

(57) ABSTRACT

A system and method of automatically prioritizing events of interest (EOIs) in a racing track by at least one processor may include: receiving, from one or more computing devices, a plurality of status data streams, each representing a condition of a respective vehicle; analyzing at least one received status data stream to identify one or more EOIs in the racing track, associated with one or more vehicles of interest; and selecting at least one EOI of the one or more identified EOIs, based on at least one priority rule.

### CROSS-REFERENCE TO RELATED APPLICATIONS

This application is a PCT International Application claiming the benefit of U.S. Patent Application No. 63/081,965, filed Sep. 23, 2020, entitled “AUTOMATED SYSTEM AND METHOD FOR CLASSIFYNG, RANKING AND HIGHLIGHTING CONCURRENT REAL-TIME EVENTS”, and U.S. Patent Application No. 63/172,240 filed Apr. 8, 2021, entitled “SYSTEM AND METHOD FOR AUTOMATED EVENTS COVERAGE BY MEDIA”, which are hereby incorporated by reference in their entirety.

### FIELD OF THE INVENTION

The present invention relates generally to monitoring of real-time events. More specifically, the present invention relates to automatically detecting and prioritizing one or more concurrent real-time events.

### BACKGROUND OF THE INVENTION

Some competition events, such as car racing, may take place over a very large area (such as the racing track) and may last from tenths of minutes to few hours and more. Many such events are characterized by high public interest in general, and very high audience interest in particular. Such events may be characterized by having plurality of momentary events of extreme interest for the audience on site and for audience watching the event from remote. Many of these momentary events may take place at locations along the racing track (or, in general terms—location on the field of event) that may not be known in advance. For example, a driver is overtaking another driver and gains a position in the race ranking. This may happen at any place along the track.

Due to the high audience interest in such events, it would be beneficial to have video cameras, microphones (and similar real-time streaming devices) located at positions that will enable documenting such timewise and location-wise unpredictable events in real time.

However, due to the unpredictability nature of these events both with regard to time of occurrence and location of occurrence, providing the desired media infrastructure based on media means located at fixed positions (or movable means with low time response and/or short operational mobility range) would require locating of a huge number of cameras (and/or microphones) which involves large budget, editorial burden, and maintenance investment.

Racing events which typically involve many vehicles spreading around a long track, also typically involve a large number of events taking place in real time, concurrently and with high level of dynamic changes. For example, a multi-lap car race with a large number of participants, may produce a very large number of race-related events, where many of them may occur concurrently or within a very short time period, making it hard or even impossible for a viewer to follow these events, and may lead the viewer to miss important event(s). Such events may be, for example, when the participant in second place bypassing the leader in a certain lap, while concurrently or nearly to concurrently the participant in the fifth location dramatically improves his performance in that lap, or as another example, the participant in the fifth position performed a driving error, lost control of his vehicle and crashed.

Additionally, it may be appreciated that race-related events may be associated with vast amount of video streams, may occupy large amount of storage, and may be challenging to effectively manage in real time or near real time.

### SUMMARY OF THE INVENTION

Embodiments of the invention may include a method of automatically producing a video clip by at least one processor. Embodiments of the method may include: receiving, from one or more computing devices, one or more respective status data streams, each representing a condition of a respective vehicle; analyzing at least one received status data stream to predict an event of interest (EOI) associated with at least one vehicle of interest; selecting at least one computing device of the one or more computing devices, based on the predicted EOI; requesting, from the at least one selected computing device, an audiovisual data (e.g., containing audio data, video data and/or both audio and video) stream; receiving the audiovisual data stream from the at least one selected computing device; and producing a video clip depicting the vehicle of interest, based on the received audiovisual data stream.

According to some embodiments, the at least one selected computing device may be associated with (e.g., installed or mounted on) the vehicle of interest.

According to some embodiments, the at least one processor may receive a first indication of location, representing a location of the vehicle of interest; receiving at least one second indication of location, representing a location of at least one respective computing device, and selecting the at least one computing device based on the first indication of location and at least one second indication of location.

According to some embodiments, the at least one processor may predict or identify an EOI by: extracting at least one feature of vehicle condition from the at least one received status data stream; inputting the at least one feature of vehicle condition to a machine-learning (ML) model, trained to output a prediction of an EOI, based on the at least one extracted input feature; and producing a prediction of expected EOI, based on the output of the ML model.

According to some embodiments, the ML model may be trained to output a prediction of an EOI further based on a profile data element, representing a profile of a driver. For example, the at least one processor may receive a profile data element, representing a profile of a driver of the vehicle of interest; input the received profile data element to the ML model; and produce the prediction of expected EOI, based on the output of the ML model.

According to some embodiments, the predicted EOI may include, for example a first vehicle of interest surpassing a second vehicle of interest; a driver of a vehicle of interest performing a driving error; a vehicle of interest experiencing a malfunction; and a vehicle of interest completing a race lap at an unexpected time.

According to some embodiments, the at least one processor may request an audiovisual data stream by: determining a beginning time stamp (BTS) value, representing a beginning of the predicted EOI; determining an end time stamp (ETS) value, representing an end of the predicted EOI; transmitting the BTS value and ETS value to the at least one selected computing device; and receiving from the at least one selected computing device an audiovisual data stream that may be limited to a timeframe defined by the BTS and ETS.

Embodiments of the invention may include a method of automatically prioritizing events of interest in a racing track by at least one processor. Embodiments of the method may include receiving, from one or more computing devices, a plurality of status data streams, each representing a condition of a respective vehicle; analyzing at least one received status data stream to predict or identify one or more EOIs in the racing track, associated with one or more vehicles of interest; and selecting at least one EOI of the one or more identified EOIs, based on at least one priority rule.

According to some embodiments, the at least one processor may compute at least one vehicle condition feature value, representing a condition of a vehicle of interest associated with the selected EOI; and present the at least one vehicle condition feature value on a user interface (UI) associated with, or communicatively connected to (e.g., via the Internet) to the at least one processor.

According to some embodiments, the at least one vehicle condition feature value may be selected from a list consisting of mechanical performance metrics of the vehicle of interest; driving performance metrics of a driver of the vehicle of interest, in a current race; and historical driving performance metrics or a performance profile of the driver.

According to some embodiments, the at least one processor may: select at least one computing device of the one or more computing devices, based on the selected EOI; requesting, from the at least one selected computing device, an audiovisual data stream; receive the audiovisual data stream from the at least one selected computing device; and produce a video clip depicting the vehicle of interest associated with the selected EOI, based on the received audiovisual data stream.

According to some embodiments, the at least one selected computing device may be associated with a mobile unit such as an autonomous vehicle or a drone. In such embodiments, the at least one processor may request an audiovisual data stream from the at least one selected computing device by sending, to a controller of the mobile unit (e.g., the drone), a command to shoot a scene in the racing track. The command may include one or more shooting parameters. The shooting parameters may include, for example a shooting location associated with the selected EOI, a shooting direction associated with the selected EOI, a BTS of the selected EOI and an ETS of the selected EOI.

According to some embodiments, the at least one processor may compute the at least one vehicle condition feature value, representing a condition of a vehicle of interest associated with the selected EOI; and integrate, or overlay a representation of the at least one vehicle condition feature value in the video clip.

Embodiments of the invention may include a system for automatically producing a video clip. Embodiments of the system may include a non-transitory memory device, wherein modules of instruction code may be stored, and a processor associated with the memory device, and configured to execute the modules of instruction code.

Upon execution of said modules of instruction code, the processor may be configured to: receive, from a one or more computing devices, one or more respective status data streams, each representing a condition of a respective vehicle; analyze at least one received status data stream to predict at least one EOI associated with at least one vehicle of interest; select at least one computing device of the one or more computing devices, based on the EOI; request, from the at least one selected computing device, an audiovisual data stream; receive the audiovisual data stream from the at least one selected computing device; and produce a video clip depicting the vehicle of interest, based on the received audiovisual data stream.

### BRIEF DESCRIPTION OF THE DRAWINGS

It would therefore be advantageous to provide a system and method that will be configured to automatically classify the large number of race-related, real time events, to rank the events according to one or more criteria and to be able to highlight events-of-interest over others.

It is also desirable to have a system and method that will be adapted to further mark video streams and audio streams along with other real time related data, and to automatically combine and edit these sources of data in a close to real time fashion, to produce a multi-media clip depicting multiple highlight moments of the chosen event.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level block diagram of a system adapted to collect and process a large number of different sources of data, according to embodiments of the invention;

FIG. 2 is a high-level block diagram of a system for collecting and processing real time data according to embodiments of the invention;

FIG. 3 is a flow diagram depicting a method of processing real time data from vehicles to automatically edit and provide video clips according to embodiments of the invention;

FIG. 4 is a schematic flow diagram depicting at high level handling of data, video and audio streams received from a vehicle by an event mapper, according to embodiments of the present invention;

FIG. 5A is a schematic illustration of car racing track 10 and a media system 100 adapted to provide short-response-time for covering an event of interest along and aside the racing track 10, according to embodiments of the preset invention;

FIG. 5B is a schematic block diagram of a central control system according to embodiments of the present invention;

FIG. 6 is a schematic block diagram of a media receive, process, and distribute module, which may be included in a system for automatically producing a video clip according to some embodiments of the invention;

FIG. 7 is a flow diagram depicting a method of automatically producing video clip by at least one processor, according to some embodiments of the invention; and

FIG. 8 is a flow diagram depicting a method of automatically prioritizing events of interest in a racing track by at least one processor, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

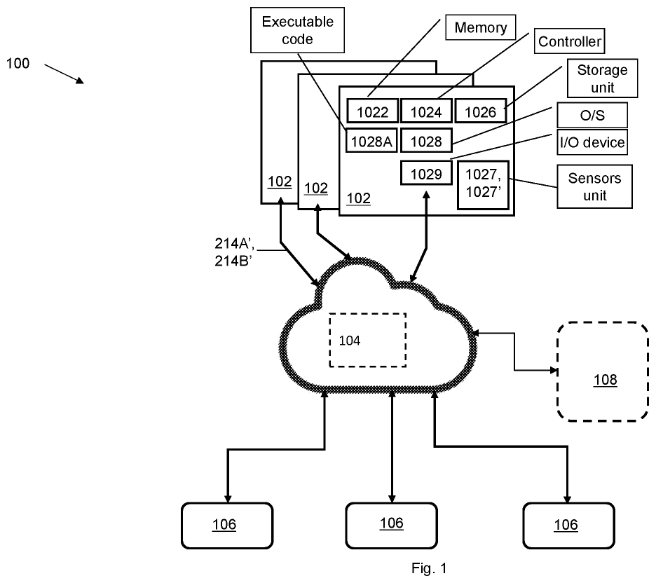

Reference is made to FIG. 1, which is a block diagram showing an example of a high level configuration of a system 100 for Automatically receiving, Classifying, Ranking and Editing multiple real time data sources according to embodiments of the present invention. This system is denoted herein as ACRE 100.

According to some embodiments, ACRE 100 may include two or more Mobile Realtime (R/T) Units (MRUs) 102 in wired or wireless communication with a central processing unit 104. ACRE 100 may further include one or more end user units 106. One or more (e.g., each) end user unit 106 may be communicatively connected (e.g., through wired or wireless communication) with central processing unit 104. Additionally, ACRE 100 may include a system administrator unit 108 that may be communicatively connected (e.g., through wired or wireless communication) with central processing unit 104.

According to some embodiments, user units 106 may be, or may include a portable or non-portable computing device that may enable a user to connect to ACRE 100 over wired and/or wireless communication channel(s). For example, user units 106 may include a personal computer (PC), smartphone, a lap-top computer, a tablet computer, and the like.

Embodiments of the invention may include an article such as a computer or processor non-transitory readable medium, or a computer or processor non-transitory storage medium, such as for example a memory, a disk drive, or a USB flash memory, encoding, including, or storing instructions, e.g., computer-executable instructions, which, when executed by a processor or controller, carry out methods disclosed herein.

For example, an article including a storage medium such as memory 1022, computer-executable instructions such as executable code 1028A and a controller such as controller 1024 may be included in a system 100 according to an embodiment of the invention.

According to some embodiments, one or more (e.g., each) MRU 102 may include a non-transitory memory device 1022, wherein modules of executable instruction code 1028A may be stored.

For example, non-transitory memory 1022 may be or may include, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 1022 may be or may include a plurality of possibly different memory units.

Additionally, MRU 102 may include a processor or controller 1024 such as a central processing unit processor (CPU) or any suitable computing or computational device, associated with memory device 1022. Processor or controller 1024 may be configured to execute the modules of instruction code, to carry out embodiments of the present invention, as elaborated herein.

Additionally, MRU 102 may include an operating system 1028. Operating system 1028 may be or may include any code segment configured to perform tasks involving coordination, scheduling, arbitration, supervising, controlling or otherwise managing operation of MRU 102, for example, scheduling execution of programs. Operating system 1028 may be a commercial operating system.

According to some embodiments, executable code 1028A may be stored on memory 1022 and/or on a storage unit 1026 and may be adapted to perform, when executed, operations and functions of embodiments of the present invention. Executable code 1028A may be any executable code, e.g., an application, a program, a process, task or script. Executable code 1028A may be executed by processor or controller 1024 possibly under control of operating system 1028. For example, a controller such as controller 1024 may execute executable code 1028A which may cause the controller to perform operations described herein. Where applicable, a processor 1024 executing executable code 1028A may carry out operations described herein in real time. MRU 102 and executable code 1028A may be configured to update, process and/or act upon information at the same rate the information, or a relevant event, are received. In some embodiments, more than two MRUs 102 may be in operative communication with ACRE 100.

According to some embodiments, storage unit 1026 may be or may include, for example, a hard disk drive, a floppy disk drive, a Compact Disk (CD) drive, a CD-Recordable (CD-R) drive, a universal serial bus (USB), a Solid state Drive (SSD) device or other suitable removable and/or fixed storage unit. Content may be stored in storage 1026 and may be loaded from storage 1026 into memory 1022 where it may be processed by controller 1024. In some embodiments, some of the components shown in FIG. 1 may be omitted. For example, memory 1022 may be a non-volatile memory having the storage capacity of storage 1026. Accordingly, although shown as a separate component, storage 1026 may be embedded or included in memory 1022.

According to some embodiments, MRU 102 may include, or may be associated with one or more input and/or output (I/O) devices 1029.

For example, I/O devices 1029 may be, or may include one or more user input device such as a mouse, a keyboard, a touch screen or pad or any suitable input device. It will be recognized that any suitable number of input devices may be operatively connected to MRU 102.

In another example, I/O devices 1029 may include one or more user interface devices such as displays, speakers and/or any other suitable output devices. It will be recognized that any suitable number of user interface output devices may be operatively connected to MRU 102.

In another example, I/O devices 1029 may be, or may include a wireless communication unit. In such embodiments, I/O devices 1029 may be configured to provide short range and/or long-range, high-speed communication channels such as Internet channel (e.g. using cellular channel or Wi-Fi channel, as is known in the art) for long range communication and Bluetooth (BT) channel for short range communication. In some embodiments long-range wireless communication channel may be used to communicate with central processing unit 104 and short-range communication channel may be used to communicate with other MRUs 102. It would be apparent to those skilled in the art that the specific selection of a wireless channel, format or standard may be done so to meet the specific conditions, such as expected distance between connecting units, maximal or average throughput of the channel/format/standard, etc.

According to some embodiments, MRU 102 may include at least one sensors unit 1027, associated with one or more respective sensors 1027′.

Sensors unit 1027 may be configured to receive data indicative of a platform to which MRU 102 is associated or attached. For example, in some embodiments MRU 102 may be attached to a vehicle and sensors unit 1027 may be configured to obtain, from one or more sensors 1027′ data indicative of the vehicle's condition and performance.

In other words, sensors unit 1027 may be adapted to provide a rich variety and a plurality of different signals, originating from a respective plurality of sensors 1027′. The plurality of signals may reflect a variety of real-world situations, and may be sent as a stream of status data (e.g., element 214A′) to central processing unit 104. Central processing unit 104 may in turn utilize the status data from sensors 1027′ to determine whether a real-world event is an Event of Interest (EOI), as elaborated herein.

For example, sensors unit 1027 may be configured to obtain data indicative of the vehicle's engine status (e.g., rounds per minute (RPM), oil pressure, oil temperature, coolant temperature, etc.).

In another example, sensors unit 1027 may be configured to obtain data indicative of the vehicle's momentary speed and acceleration, including for example linear, one-dimensional (1D) momentary speed and/or acceleration, spatial, three-dimensional (3D) momentary speed and/or acceleration, and the like.

In another example, sensors unit 1027 may be configured to obtain data or signals indicative of the vehicle's driving operations, such as steering wheel position, acceleration pedal position, gear position, and the like.

In another example, sensors unit 1027 may be configured to obtain audio and/or video streams from one or more cameras and microphones disposed in the vehicle or on the vehicle.

In another example, sensors unit 1027 may be configured to obtain data indicative of the MRU's 102 location in a global reference system (e.g., geographical coordinates system) using for example systems such as a Global Navigation Satellite System (GNSS), a Global Positioning System (GPS), and the like, as is known in the art.

In some embodiments, one or more sensors 1027′ of sensors unit 1027, may be embedded or may be part of MRU 102.

In another example, sensors unit 1027 may be, or may include a nine degrees of freedom unit, commonly referred to in the art as a 9 DOF unit.

According to some embodiments, one or more MRUs 102 may be configured to receive signals and/or data from one or more sources associated with MRU 102. For example, some MRU 102 may be adapted to receive data from a sensor 1027′ that is video camera, attached to the vehicle, and associated with the MRU 102. MRU 102 may receive a video data stream from camera 1027′, along with spatial data or signals. Such spatial data or signals may include, for example location of the MRU 102 in global coordinates, spatial direction of the camera's field of view (FOV), the camera's Pan, Tilt and Zoom (PTZ) parameter values, and the like.

Additionally, or alternatively, MRU 102 may obtain from a sensor 1027′ such as a video camera video and/or audio streams along with time stamps that mark the time of events captured in the video and/or audio streams. The time stamps may, for example be based on a global or a local or a proprietary time system.

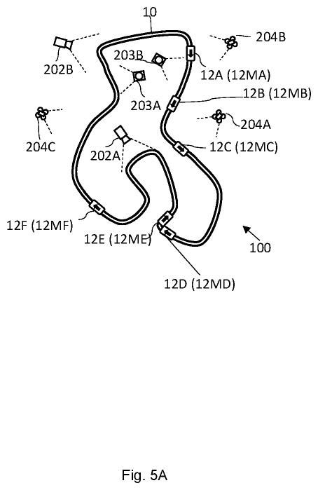

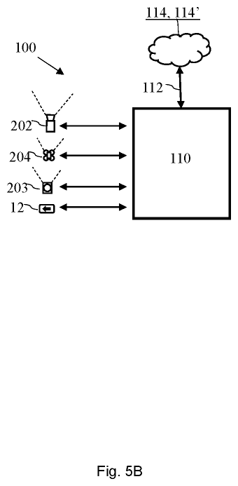

According to some embodiments, video and audio streams may be provided to central processing unit 104 from stationary sources or sensors, such as stationary video cameras (e.g., element 202 of FIG. 5A) that may be disposed in the vicinity of the place where events take place. In some embodiments at least some of such stationary cameras may be adapted to provide to central processing unit 104 their PTZ information along with their stream of video.

In some embodiments MRU 102 may further be adapted to provide the identity of a user or person operating the vehicle. In further embodiments additional information associated with a person operating a vehicle (e.g., a race driver) may be available to central processing unit 104. Such information may include driver's ranking based on previous races, driver's nature of driving (e.g., patient, risk taker, aggressive, etc.), driver's history of tendency (e.g., driver's tactics), etc. Driver's characteristics may be provided to central processing unit 104 from storage means available to central processing unit 104.

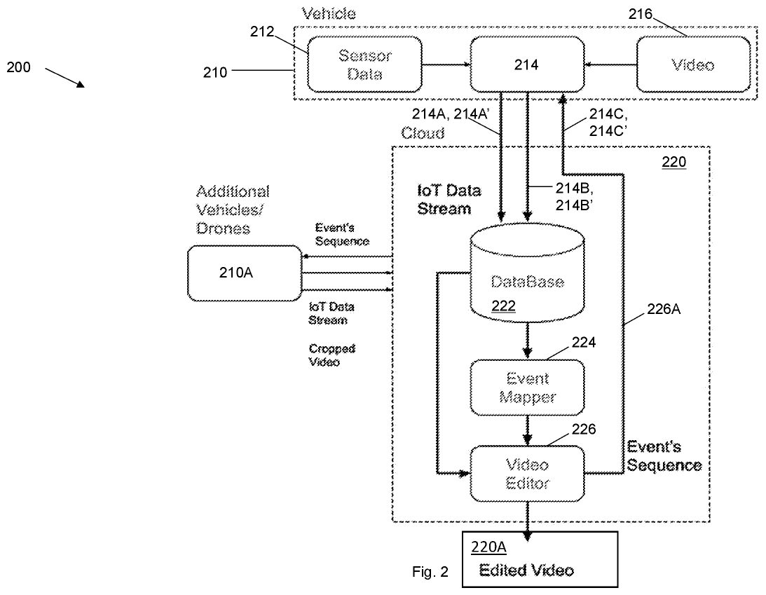

According to some embodiments, MRU 102 may be configured to receive data from sensors unit 1027 and associate each stream of data with appropriate time stamps, in order to enable synchronization of two or more streams of data with each other along a common timeline. MRU 102 may split the streams of data received from sensors unit 1027 into a plurality (e.g., two) groups: a first group may include time-stamped data streams (e.g., element 214A′ of FIG. 2) that occupy relatively low storage and/or transmission volume. A second group may include time-stamped data streams (e.g., element 214B′ of FIG. 2) that occupy relatively (e.g., in relation to the first group) high storage and/or transmission volume.

The first group may include, for example, data reflecting vehicle's health, performance, and location. The second group may include, for example video streams and/or audio streams.

The association of a data stream to one of the groups may be based on the time required to transmit that stream of data over the wireless channel (e.g., elements 214A, 214B of FIG. 2) used for communication between an MRU 102 and central processing unit 104.

According to some embodiments, central processing unit 104 may determine an over-all latency (OAL) parameter value, pertaining to production of a video clip. The OAL parameter value may be defined as the time between the occurrence of an event and the time a video clip presenting that event is made available for viewing at a user's unit 106. In other words, in order to provide time-based processed video clips that may include video and audio sections along with other data reflecting the vehicle's health and performance in virtually real time, ACRE system 100 may process the incoming data streams based on the OAL parameter value.

For example, MRU 102 may group, or classify time-stamped data streams to the plurality of groups based on the OAL parameter value, according to equation Eq. 1, below:

a. upload_time<[OAL−(processing time+download_time)]→first group

b. upload_time>[OAL−(processing time+download_time)]→second group Eq. 1
where upload_time is defined as the time required for transmitting the relevant time-stamped data stream from MRU 102 to central processing unit 104;
processing_time is defined as the time required for processing the relevant time-stamped data stream to produce a video clip; and
download_time is defined as the time required for transmitting the video clip from central processing unit 104 to a user unit 106.

For example, the first group of time-stamped data streams may include data streams for which an upload time may be substantially smaller than the allowed OAL, minus the time of processing the video clip and transmitting the video clip to a user's unit 106. In another example, the second group may include streams of data which the time required for transmitting them as a whole (e.g., an entire feed) to central processing unit 104 may be substantially larger than the allowed OAL minus the time of processing the video clip and transmitting the video clip to a user's unit 106.

In some embodiments MRU 102 may be configured to continuously send a composed stream of data of the first group to central processing unit 104, either upon request from central processing unit 104 or initiated by MRU 102.

In some embodiments MRU 102 may be configured to receive requests from central processing unit 104 to send specific chunk or chunks 214B′ from a defined video stream. These chunks may be defined, according to embodiments, by defining a beginning time stamp (BTS) and ending time stamp (ETS) of the video chunk or stream 214B′.

Central processing unit 104 may be or may include hardware and/or software units adapted to perform methods described herein. In some embodiments, central processing unit 104 may be implemented using cloud-based services such as cloud-based storage resources and/or cloud-based computing resources. In some embodiments central processing unit 104 may be implemented as a combination of cloud-based computing resources and local computing resources. As explained in detail herein below, central processing unit 104 may be adapted to receive streams of data 214A′, 214B′ from multiple MRUs 102, and process these streams of data in order to identify and/or define one or more EOIs in these streams of data. Central processing unit 104 may subsequently send to one or more MRU 102 a request for delivering one or more specified chunks or streams 214B′ of video and/or audio streams, defined by the BTS and/or ETS of the requested chunk.

Central processing unit 104 may further be configured to infer EOIs based on analysis of the plurality of received signals, data from sensors unit 1027, and data stored in storage associated with central processing unit 104.

Reference is made now to FIG. 2, which is a high-level block diagram of system 200 for collecting and processing real time data according to embodiments of the invention. System 200 may include functionalities and components similar to ACRE system 100 of FIG. 1.

For example, system 200 may include a central processing unit 220 in operative communication with one or more mobile platforms 210, 210A. According to some embodiments, central processing unit 220 may be similar to central processing unit 104 of FIG. 1. Alternatively, central processing unit 220 may include functionalities and components similar to central processing unit 104 of FIG. 1.

Mobile platforms 210, 210A may be associated with, or may be included in a racing vehicle, an emergency vehicle, a drone, a balloon, and the like. In some embodiments, mobile platforms 210, 210A may be similar to MRU units 120 of FIG. 1. Additionally, or alternatively, mobile platforms 210, 210A may include functionalities and components similar to MRU 102 of FIG. 1.

Mobile platform 210 may include sensors 212 having similar functionalities and components to sensors 1027′ and/or sensors unit 1027 of FIG. 1. Sensors 212 may provide sensor data to a central processing unit 214, similar to controller 1024 of FIG. 1. Additionally, or alternatively, mobile platform 210 may include one or more sensors 212 that are video cameras, which may be configured to provide video streams of events taking place around respective mobile platform 210, 210A to processing unit 214.

Central processing unit 220 may include and/or may be in operative communication with a database (DB) 222, with event mapper unit 224 and with automated video editor unit 226.

According to some embodiments, central processing unit 220 may be configured to receive streams of data, e.g., status data streams 214A′ from one or more processing units 214 of one or more respective mobile platforms 210, for example via wireless channel 214A. Central processing unit 220 may store content of the received streams of data 214′ on DB 222.

Channel 214A may be used for transmitting data of types related the first group of data, also referred to herein as status data streams 214A′, as described above. Status data streams 214A′ of the first group that are received and stored in DB 222 may be stored under any known storage scheme and may be tagged so as to allow accessing and fetching each portion of any data stream from any source of data, for example based on the time stamps associated with the streams of data.

Central processing unit 220 may scan the stored data in DB 222, and process this data so as to identify or determine events of interest (EOI). An EOI may be defined as event reflected by at least a portion of one or more of the data streams stored in DB 222, which is considered of interest for at least one end user (e.g., a user of user unit 106 of FIG. 1).

The level of interest of users in an EOI may be defined based on past interest (as may be recognized by the user's viewing similar type of events for longer times than other types of events), or may be defined based on moments of high interest as known for specific types of long-lasting events, such as a moment when a race car bypasses another car in a race event. Other indications for an EOI may be sharp change in the value of, for example, the forward acceleration of a vehicle (or a sharp breaking), and the like.

Example of an event that may be classified as an EOI may be overtaking of one vehicle by another vehicle during the race session. Such event may be identified based on, for example, relative position of the involved vehicles on the track. Early identified of an overtake may be calculated, for example, using AI tools, considering various parameters and additional data such as steering wheel position, throttle and brake application, driver's heartrate, current speed-mark of each of the drivers, current risk-taking mark of each of the drivers, location on the track where the overtaking took place, change of the driving nature of the driver being overtaken during the event, and the like.

Another example of an event that may be classified as an EOI may be a driving error made by a given driver. Such event may be identified by a sharp change in the driver relative location on the track, sharp change in his speed at an unexpected location, unexpected change in the driver's lap average performance, etc. The importance of an identified driver's error may be calculated, for example, using AI tools, considering various parameters such as the driver's performance tendency, the location on the lap, etc. An AI based tool may be adapted to identify driver's driving error rather quickly by considering parameters such as past performance of the driver in that race/that lap/that location, and the like.

The above examples may provide basis for enhancing a viewer interest by including information related not only to “what happened” but also “why it happened”—what lead to the EOI. Further, such capabilities of the system may enable providing to a viewer, in addition to the presented driver's driving error, what are the direct consequences of that driving error and what lead to that error.

The decision what makes a certain portion of the timeline of events an EOI is made by event mapper 224. In some embodiments event mapper may be provided with a kind of rich look-up table defining what combination of momentary values of reflected data, stored in DB 222, may be defined as EOI. The rich look-up table may include momentary values of any type of data provided and/or available to event mapper 224, such as vehicle momentary speed and acceleration in combination with the vehicle's driver history of driving which may lead to event mapper 224 decision that combination is associated with a start moment of an event “vehicle is accelerating to bypass (or overtake) another vehicle”.

In some embodiments, event mapper 224 may define EOIs based on association of drivers' performance and/or cars' health/status of two or more cars participating in a race.

Event mapper 224 may thus define an EOI that represents a current or shortly expected interaction between the two or more cars in the race. Similarly, event mapper 224 may decide what is the combination of momentary values defining the end of that EOI.

Additionally, event mapper 224 may identify certain types of EOI by comparing a first data element representing performance and/or status of a first vehicle, with a corresponding data element, representing performance and/or status of a second vehicle.

For example, an EOI reflecting occurrence of a first vehicle overtaking a second vehicle may be inferred from the continuous comparison of the location of each of the first and second vehicles, as received, for example, by central processing unit 220. Event mapper 224 may continuously verify and check in substantially real time the numerous momentary potential combinations defining a beginning (e.g., BTS) and/or an end (e.g., ETS) of an EOI. This way one or more EOIs may be defined in substantially real time.

In some embodiments of the invention, event mapper 224 may define a BTS and ETS of an EOI based on past interest in similar events that were recorded, during the current long lasting event or during other similar events. Additionally, or alternatively, event mapper 224 may define one or more EOIs based on past interest of a user (e.g., user 106 of FIG. 1) that is currently connected to system 100.

In other embodiments event mapper unit 224 may use artificial intelligence (AI) tools to analyze in substantially real time the multiple streams of data in order to continuously define one or more EOIs. Event mapper 224 using AI tools may be trained by introducing training sets reflecting level of interest (“popularity”) of plurality of events from previous races. Trained AI tool may be tuned from time to time using additional training sets or by relying on updated popularity of EOI, as reflected by the interest of viewers, as is known in the art.

Each EOI that is defined by event mapper 224 is denoted by its beginning time stamp BTS and its end time stamp ETS. Event mapper 224 may provide these time stamps to automated video editor 226. Video editor unit 226 may include software and/or hardware units (or cloud-based such functionalities) adapted to edit video clips from some or all of the data streams occurring between the BTS and ETS time stamps of the EOI. Video editor may simultaneously issue a request 226A for one or more video chunks or streams 214B′ that are associated with the EOI. Request 226A may be transmitted to the respective platforms 210 via transmission channel 214C. the respective platform 210 may respond by cutting the requested audiovisual (e.g., audio, video and/or both) chunk or stream 214B′ of data from the still lasting and accumulating video stream and transmit it to central processing unit 220 via transmission channel 214B.

In other words, central processing unit 220 may be able to analyze on-going incoming multiple streams of data, to define or determine one or more EOIs. Central processing unit 220 may subsequently request and receive from mobile units 210, 210A only video chunks or streams 214B′ associated with the EOIs, and produce a video clip that covers the identified EOIs.

Thus, central processing unit 220 may produce an EOI data element that is associated with, or includes one or more relevant video chunks or streams 214B′ in real time or near real time. Embodiments of the invention may therefore include an improvement over currently available technology of video editing, which may resort to transferring very large (e.g., in the order of Gigabytes) video files from a plurality of data sources that may, or may not be relevant to the EOI, and subsequent manual editing of the video files. It may be appreciated that such manual process may typically take several hours, and may be only initiated after the race has terminated.

According to some embodiments, central processing unit 220 may provide an edited video clip that may include, in addition to the video chunk or streams 214B′, multiple different types of associated data that may be presented as part of the edited video clip. For example, central processing unit 220 may embed data of the first group 214A′, received via communication channel 214A in the video frames received over communication channel 214B.

According to some embodiments, central processing unit 220 may include a video editor module 226, configured to determine the way the data added to the video frame is presented (e.g., location in the frame, size, color, and other attributes), based on pre-defined templates or as a result of editing decisions made by the AI in event mapper 224. The edited video may be transmitted to one or more users. It may be noted that central processing unit 220 may edit concurrently more than one video clips. For example, central unit may edit two different video clips concurrently, each of them may be edited in line with different lines of editing.

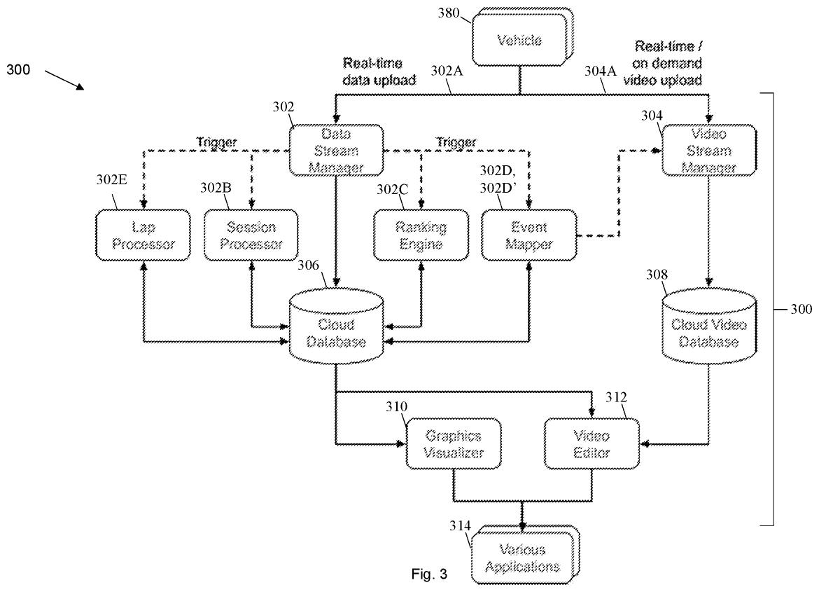

Reference is now made to FIG. 3, which is a schematic flow diagram, depicting a structure 300 of flow paths of data received from one or more vehicles. In ither words, structure 300 may represent a method of processing real time data from vehicles to automatically edit and provide video clips according to embodiments of the invention.

As shown in the example of FIG. 3, Structure 300 depicts several functionalities that handle data associated with a vehicle. For example, data of structure 300 may be indicative of vehicle performance, vehicle status, video and audio streams received from the vehicle, and the like.

According to some embodiments, structure 300 may enable the operations described above with regards to FIG. 2 and may be performed, for example, by central processing unit 220 of FIG. 2. It would be apparent to those skilled in the art that some of the functionalities of structure 300 may be performed by one or more computing devices.

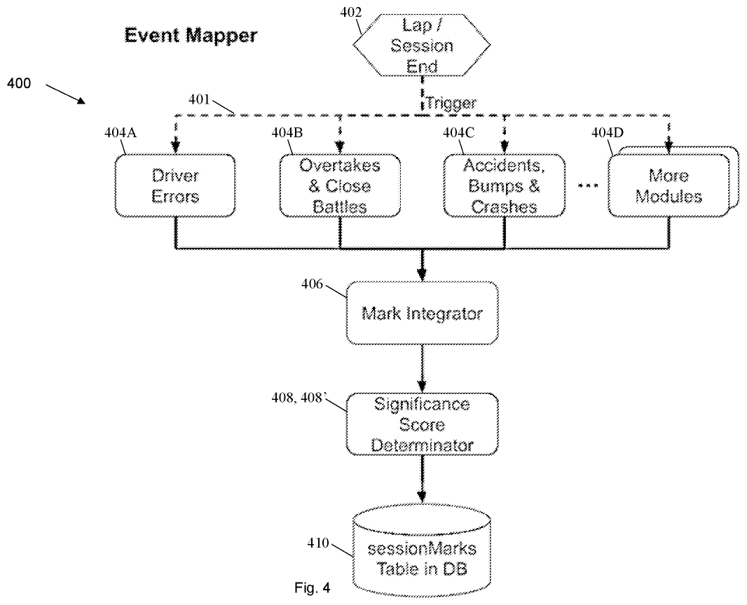

According to some embodiments, one or more vehicles 380 (or platforms, such as platform 210 of FIG. 2) may each provide continuous streams of data 302A to data stream manager unit 302 and video on-demand chunks 304A to video stream manager 304. Data stream manager 302 may be configured to analyze the stream of data and to direct such stream to one (or more) of lap processor 302E, session processor 302B, ranking engine 302C and event mapper 302D as elaborated herein (e.g., in relation to FIG. 4).

According to some embodiments, event mapper 302D may be similar to event mapper 224 of FIG. 1. Event mapper 302D may issue a request for providing a defined video chunk from a respective platform 380. The video chunk that is received may be stored in video database 308. The results of analyzed event-associated data may be stored in events database 306, already tagged to indicate, for each of the data portions associated with an event of interest, to be associated to that EOI 302D′.

The data streams that were grouped to be associated with a common EOI 302D′ may be directed to graphics visualizer editor 310 and to video editor 312. Graphics visualizer 310 may be configured to edit the received data for presenting as overlay graphics to be presented in the frames of the associated video chunk. Concurrently video editor 312 may receive the respective video chunk from video DB 308. The composed video clip, included of the respective video chunk and the added graphics presenting associated data, and optionally respective audio and further optionally background (AKA ‘under’) musical clip, may be provided to various external applications, e.g., user's screen.

Reference is made now to FIG. 4, which is a schematic flow diagram 400 depicting at high level handling of data, video and audio streams received from a vehicle by an event mapper (such as event mapper 302D of FIG. 3), according to embodiments of the present invention.

According to some embodiments, real time streams of data (e.g., real time data 302A, 302D of FIG. 3), may be provided to a plurality of event-type functionalities and may initiate one or more triggers for their operation trigger (block 402). Such trigger(s) may initiate function of one or more modules, including for example a driver error analyzer module 404A, an overtakes and close battles analyzer module 404B, an accidents, bumps and crashes analyzer module 404C and optionally additional analyzer module(s) 404D, relating to additional events of interest. Each one of modules 404A-404D may be configured to analyze the incoming status data stream 214′ in order to predict, identify, tag and/or provide indication of a respective EOI 302D′.

According to some embodiments, one or more analyzer modules 404A-404D may include rule-based logic, adapted to predict, or identify occurrence of a respective real world event. For example, overtakes analysis module may receive status data streams 214A′ that may include information representing momentary location, speed, and acceleration of two or more vehicles, and may apply a predefined rule on this information to produce a prediction that an overtake event is likely (e.g., beyond a predefined probability) to occur within a predefined, upcoming time frame.

Additionally, or alternatively, the one or more analyzer modules 404A-404D may be, or may include a machine-learning (ML) model, trained to output a prediction of an EOI, based on the at least one input feature. For example, the one or more analyzer modules 404A-404D may be configured to extract at least one feature of vehicle condition 401 (e.g., momentary location, speed, acceleration, and steering actions) from the at least one received status data stream 214A. Analyzer modules 404A-404D may subsequently input or introduce the at least one feature of vehicle condition 401 to the respective ML model. Analyzer modules 404A-404D may then produce an indication of occurrence, or a prediction EOI 302D′ of an expected event of interest, based on the output of the ML model.

Additionally, or alternatively, analyzer modules 404A-404D may be configured to produce an identification of occurrence of an EOI, or a prediction of an expected or upcoming 302D′ further based on a profile data element, representing a profile of at least one relevant driver.

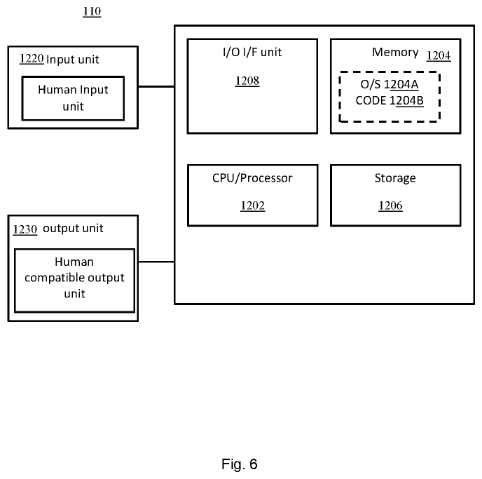

For example, analyzer modules 404A-404D may receive (e.g., from input unit 1220 of FIG. 6) at least one data element representing a profile of a driver, and apply a predefined rule to the profile data element and/or input features of status data stream 214A′ to predict EOI 302D′.

Additionally, or alternatively, the ML model of Analyzer modules 404A-404D may be further trained to produce prediction EOI 302D′ further based on the driver profile data element. Embodiments of the invention may therefore receive a profile data element, representing a profile of a driver of the vehicle of interest; input the received profile data element to the ML model 401′ (e.g., in addition to feature of vehicle condition 401 obtained from status data stream 214A′); and produce the prediction of expected EOI 302D′ based on the output of the ML model.

According to some embodiments, the driver profile data element may include, for example information pertaining to physical characteristics of the driver, including for example the drivers speed, characteristics of the driver's performance, characteristics of the driver's stamina or endurance, characteristics of the driver's aggression (e.g., in performing steering, braking, and use of a throttle), and characteristics of the driver's experience.

Additionally, or alternatively, the driver profile data element may include, for example information pertaining to cognitive characteristics of the driver, including for example the driver's consistency (e.g., during steering, braking, usage of throttle, and driving lines); the driver's overtaking ability; the driver's overtaking quality; the driver's defensive capabilities; the driver's average time or distance between errors; the driver's “rhythm” or “warming rate”; and the driver's capability of leading.

Additionally, or alternatively, the driver profile data element may include, for example information pertaining to psychological characteristics of the driver, including for example the driver's pressure resilience; the driver's tendency for risk-taking; characteristics of the driver's volatility; and characteristics of the driver's Intelligence.

Additionally, or alternatively, analyzer modules 404A-404D (and/or respective ML models) may be configured or trained to produce an identification of occurrence of an EOI, or a prediction of an expected or upcoming 302D′ further based on characteristics of the racetrack. Such characteristics of the racetrack may include, for example circuit overtake ability, curve overtake ability, effect of rain on curve overtake ability, and the like.

The identified and tagged EOI 302D′ that are provided by modules 404A-404D which relate to same vehicle or to same competing pair/group of vehicles (and therefore may relate to common EOI 302D′) are processed by a mark integrator module 406 in order to group these associated EOI 302D′ to one Event that is given a unique event mark ID (UEMI).

In some embodiments the process described above may be used to create and edit in close to real time EOI 302D′ including plurality of different types of event—related data and associated video chunks. In some embodiments the process may create a close to real time EOI 302D′ presentation based on real time considerations and decisions and may further re-edit the previously edited EOI 302D′ presentation based on further data that was received at later time.

For example, an EOI 302D′ presentation may present an overtake of a driver in the fourth position by a driver in the fifth position—an event that may be accorded high ranking of interest to a driver or a viewer during a given part of a lap of the race. The driver in the fourth position that was overtaken by the driver in the fifth position may regain his leading position down the same lap sending the other driver back in the queue, either due to high level of driving skills or due to a driving mistake by the other driver. Each of those overtakes may create separate momentary EOIs 302D′, but following the second overtake the system may decide to merge those two EOI 302D′ together into a single EOI 302D′ described as “close battles”.

Significance score determinator module 408 is configured to receive the Events with their associated UEMIs and to calculate for each event an associated event significance score (ESS). This ESS may be used to evaluate the importance of the associated event in a context of the entire respective session. The term “importance” may be used in this context to indicate a relative level of expected interest in that event for a given viewer. According to some embodiments of the invention, the importance of a given event may be dynamically updated.

For example, the average level of interest of plurality of viewers in given types of events may be re-measured dynamically and the parameters used for calculating the respective significance may be changed in accordance. Additionally, or alternatively, the dynamics of the significance may be subject to AI tools embedded in the central computing unit. According to embodiments of the invention the importance of a given event may be determined, additionally or in combination with a set of priority rules 408′ that is based on the sport's logical behavior. The set of priority rules 408′ may be edited and modified but are unrelated to the viewers.

For example—overtake on the first place may be considered as more significant than and overtake on the third place. In another example, an overtake made by a driver which has an overall poor performance profile may be considered as more significant than an overtake performed by a driver which has an overall superior performance profile. In another example, an accident involving a vehicle that is a contender for a title may be considered as more significant than an accident that does not involve a contender. Additional priority rules 408′ may also be applied.

The various significance marks and their associated events may be stored in an ordered structure (e.g., a table) in session marks table module at block 410, for further use by system 100.

A field where a sport event may take place may be as large as few square kilometers and with length dimension as long as, for example, 2 kilometers. Reference is made now to FIG. 5A, which is a schematic illustration depicting an example of deployment of a media system 100 in a setting of a car racing track 10. Media system 100 of FIG. 5A may be or may include one or more modules of system 100 as elaborated herein (e.g., in relation to FIG. 1).

According to some embodiments, system 100 may be adapted to provide short-response-time for covering an event of interest along and aside the racing track 10, according to embodiments of the present invention.

Reference is also made to FIG. 5B, which is a schematic block diagram depicting application of media system 100, according to embodiments of the present invention.

As shown in FIG. 5B, media system 100 may include one or more computing devices that are media transmit and/or receive units (e.g., denoted 12AM-12FM). Media units 12AM-12FM may be associated with respective race cars (e.g., denoted 12A-12F, respectively). Additionally, or alternatively, media system 100 may include one or more computing devices that are stationary cameras 202A-202B, mobile cameras 203A-203B and/or aerial camera units 204A-204C.

According to some embodiments, media system 100 may include a media receive, process, and distribute (MRPD) module 110. MPRD 110 may be, or may include modules of central processing unit 104 as elaborated herein (e.g., in relation to FIG. 1).

According to some embodiments, a plurality of race cars 12 (e.g., 12A-12F) may participate in a car race along track 10, and may be at any location along the track, or aside it, during the race. Race cars 12 may also be in relative positions with respect to each-other that may change dynamically, during the race. One or more race cars 12 (e.g., 12A-12F) may be equipped with a car's Data Collecting and Transmitting (DCT) unit 12M (e.g., elements 12MA-12MF respectively). The one or more DCT units 12M may be, or may include modules of MRU 102, as elaborated herein (e.g., in relation to FIG. 1).

DCT units 12M may be configured to collect and/or monitor status parameters 401 (also referred to herein as vehicle condition feature value 401) representing a condition of a car participating in the race. For example, DCT units 12M may be configured to collect status parameter values representing the car's performance parameters with respect to the mechanic, electric and/or electronic assemblies. Additionally, or alternatively, DCT units 12M may be configured to collect status parameter values representing the car's performance in relation to the racing track, including for example the car's location (e.g., absolute and/or relative position of the car), direction, speed, acceleration, and the like. Additionally, or alternatively, DCT units 12M may be configured to collect status parameter values representing, driving operations, including for example accelerating, braking, steering, shifting gears, etc.

DCT units 12M may be configured to transmit (e.g., via communication channel 214A of FIG. 2) some or all of the collected data (e.g., status data streams 214A′) to remote units such as central processing unit 104 of FIG. 1. Additionally, or alternatively, two or more DCT units 12M may be configured to communicate with each other using a vehicle data network 114′.

As shown in FIG. 5A, racing field 10 may be equipped with a plurality of stationary cameras 202 (e.g., 202A, 202B), which may be positioned at locations that may have high chance to capture race-related events of interest happening inside their field of view. Cameras 202 may be stills cameras, video cameras, IR cameras and the like. Cameras 202 may have fixed lines of sight (LOS) or adjustable LOS, fixed focal length or a controllable focal length.

For example, cameras 202 may remotely be controlled by a media receive, process and distribute unit MPRD such as unit 110 of FIG. 5B or central processing unit 104 of FIG. 1. Stationary cameras 202 may by of the pan-tilt-zoom (PTZ) type, which enable remote control of their pan, tilt and zoom parameters. Cameras 202 may be connected to a MPRD 110 unit via wired channel(s) or wireless channel(s).

Additionally, or alternatively, mobile camera units 203 (e.g., 203A, 203B) may have the desired mobility to move around in relation to racing field 10, for example in order to reach good picture-taking locations, with respect to dynamic events at the field. Mobile units 203 may be, for example, 4×4 vehicles with good terrain maneuverability, having one or more video cameras installed on them. According to embodiments of the invention units 203 may be configured to communicate wirelessly with MRPD 110, and receive from MRPD 110 transmission containing position at the field to go to and video/stills shooting parameters (e.g. where on the track or near it is the zone of interest, how long from the receipt of the transmission an event of interest is expected to take place at the defined target location, what are the desired shooting angles, and the like). Mobile unit camera 203 units may be manned or unmanned. Unmanned mobile camera units 203 may be controlled from a central processing unit 104/MPRD 110 by controlling the travel path to a new target point and by providing shooting direction. In some embodiments part of the control of a mobile camera unit 203, the mobile unit may provide on-line data to the control unit reflecting its position, presenting its line of movement and the like—to ease its control.

Additionally, or alternatively, aerial camera units 204 (e.g., 204A, 204B, 204C) may be autonomous aerial camera units, such as drones equipped with cameras, that may be remotely controlled, e.g., from the central control unit 104/MPRD unit 110. Aerial camera unit 204 may be equipped with controlled camera (e.g., controlled PTZ camera) and the aerial vehicle may be controlled so as to direct its flight path and stop position (e.g., height and/or geographical coordinates) and its heading to assist in acquiring a desired video and/or still images shooting position. Aerial camera unit 204 may provide to central control unit 104 data reflecting its position and heading, stream of video and/or still images, 204 unit's status parameters (e.g., remaining flight time, remaining flight distance, location, height, and the like).

Reference is made now to FIG. 6, which is a schematic block diagram of MPRD unit 110, according to embodiments of the invention.

According to some embodiments, MPRD unit 110 may be located or installed in physical proximity to racing track 10. Alternatively, MPRD unit 110 may be located or installed remotely, and may utilize remote computing resources. For example, MPRD 110 may be embodied using available non-specific computing and storing resources available in a cloud computing system, and may communicate to one or more computing devices such as MRU(s) 102, DCT units 12M associated with race cars 12, and/or camera devices (e.g., 202, 203, 204) via a computer network such as a mobile communication network.

MPRD unit 110 may comprise a controller or processor 1202, memory unit 1204, storage device 1206 and input/output (I/O) interface (I/F) unit 1208. Each one of processor 1202, memory unit 1204, storage device 1206 may be embodied by a single computing device unit or a single platform or embodied by a collection of two or more respective unit(s), which may be located in a common location or may distributed. MPRD unit 110 may further include input unit 1220 and/or output unit 1230. Input unit 1220 and/or output unit 1230 may be, in some embodiments, interface units providing connectivity to communication or signals sent to MPRD 110 or sent by MPRD unit 110.

Processor 1202 may be, for example, a central processing unit processor (CPU), a chip or any suitable computing or computational device. Processor 1202 (or one or more processors, possibly across multiple units or devices) may be configured to carry out methods described herein, and/or to execute or act as the various modules, units, etc. More than one MPRD unit 110 may be included in, and one or more MPRD units 110 may act as the components of a system according to embodiments of the invention.

Memory unit 1204 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 1204 may be or may include a plurality of possibly different memory units. Memory unit 1204 may be a computer or processor non-transitory readable medium, or a computer non-transitory storage medium, e.g., a RAM.

Storage unit 1206 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) storage device or other suitable removable and/or fixed storage unit. Content may be stored in storage unit 1206 and may be loaded from storage unit 1206 into memory unit 1204 where it may be processed by processor 1202. In some embodiments, some of the components shown in FIG. 2 may be omitted. For example, memory unit 1204 may be a non-volatile memory having the storage capacity of storage unit 1206. Accordingly, although shown as a separate component, storage unit 1206 may be embedded or included in memory unit 1204.

MPRD unit 110 may further include I/O interface (I/F) unit 1208, which is configured to enable communication and connectivity of input unit 1220 and output unit 1230 to MPRD unit 110. Processor 1202, memory unit 1204, storage unit 1206 and I/O interface unit 1208 may be in operational connection with each other.

Input unit 1220 may be or may include any suitable input devices, components or systems, e.g., a detachable keyboard or keypad, a mouse, a touch screen, a microphone and the like. Output unit 1230 may include one or more (possibly detachable) displays or monitors, speakers and/or any other suitable output devices. Any applicable input/output (I/O) devices may be connected to MPRD unit 110 as shown by blocks 1220 and 1230.

For example, a wired or wireless network interface card (NIC), a universal serial bus (USB) device or external hard drive may be included in input devices 1220 and/or output devices 1230. It will be recognized that any suitable number of input devices 1220 and output device 1230 may be operatively connected to MPRD unit 110 as shown by blocks 1220 and 1230.

MPRD computing system 110 may include an operating system 1204A that may be stored or loaded into memory unit 1204. Operating system 1204A may be or may include any code segment (e.g., one similar to executable code 1204B described herein) designed and/or configured to perform tasks involving coordination, scheduling, arbitration, supervising, controlling or otherwise managing operation of MPRD unit 110, for example, scheduling execution of software programs or tasks or enabling software programs or other modules or units to communicate. Operating system 1204A may be a commercial operating system. It will be noted that an operating system 1204A may be an optional component, e.g., in some embodiments, a system may include a computing device that does not require or include an operating system 1204A. MPRD computing system 110 may include executable code 1204B which may be any executable code, e.g., an application, a program, a process, task or script. Executable code 1204B may be executed by processor 1202, possibly under control of operating system 1204A. Although, for the sake of clarity, a single item of executable code 1204B is shown in FIG. 6, MPRD computing system 110 may include a plurality of executable code segments similar to executable code 1204B that may be loaded into memory unit 1204 and cause processor 1202, when executed, to carry out methods described herein.

According to some embodiments of the present invention MPRD unit 110 may be in operational communication with one or more remote computing devices and/or storage units, commonly depicted herein by remote/additional computing/storage resource (e.g., element 114 of FIG. 5B) via communication channel(s) (e.g., element 112 of FIG. 5B). Computing/storage resource 114 may be implemented by cloud-based resources. In some embodiments one or more of the functionalities performed by MPRD unit 110 may be carried out by remote computing facilities 114 such as cloud-based computing resource, cloud-based storage resource, and the like.

One or more programs stored in storage unit 1206 may be loadable to memory unit 1204 and executable by processor unit 1202 to perform one or more of the methods and processes described herein. It will be appreciated that the central processing unit 104/MPRD unit 110 missions may be performed entirely by central processing unit 104/MPRD unit 110 itself. Alternatively, in some embodiments, storage of portion of the data, as well as computing jobs may be assigned to remote computing and/or storage resources 114.

According to some embodiments, data and video may be collected in real time by DCT unit 12M from the vehicle data network and/or from the car's internal sensors, and video from on-car camera(s). In the central processing unit 104/MPRD unit 110 and/or computing/storage resource 114, the data may be analyzed by an event mapper functionality (e.g., event mapper 400 of FIG. 4, event mapper 302D of FIG. 3) which may analyze in a near-real time fashion the flow of incoming data from the plurality of sources and identify which occurrences at the racing field may be defined as EOI 302D′ in real time. Based on the dynamically identified EOI(s) that take place at any given moment, and the location where each of these events take place at the racing track 10, central processing unit 104/MPRD unit 110 may automatically and/or remotely control and direct camera platforms (e.g., 202, 203, 204) to cover one or more of these EOI(s).

Central processing unit 104/MPRD unit 110 may study how each event may best be covered (e.g., from which angle, by how many cameras, which are the camera units that may best cover that event, etc.). Central processing unit 104/MPRD unit 110 may learn the above by processing broadcasts of race events (using computer vision techniques) as well as based on cars' received performance data.

According to some embodiments, central processing unit 104/MPRD unit 110 may further use artificial intelligence (AI) and deep learning tools in order to achieve high hit-rate of prediction the time, location, and/or nature of occurrence of an EOI 302D′. Based on that information and prediction calculations, the system may direct one or more of the cameras to provide optimal event coverage for each event. Central processing unit 104/MPRD 110 may be configured to use computer image processing tools in order to close a control loop in order to make sure the image it receives from the cameras (e.g., 202, 203, 204) with respect to a given event is the one required, and may adjust/readjust the selection of images accordingly if not.

According to some embodiments, any previously taken series of field inputs such as video streams 214C′, and status data streams 214A′ (e.g., vehicle performance information) may also be used by the control system 104/MPRD unit 110 as a training set for the improvement of the system's prediction performance. Such improvement of prediction performance may be recognized, for example, as an increased percentage of the system's successful prediction that an EOI 302D′ is currently occurring or about to happen. Additionally, or alternatively, an improvement of prediction performance may be recognized as the system's ability to predict the occurrence of such EOI longer in advance.

In some embodiments, the system may further be trained by an input from remote followers of the events identified as EOIs 302D′, for example by receiving indication of the popularity of such events. Such training may be used by control system 104/MPRD unit 110 to continuously tune the editing of the video clips prepared and broadcasted to the audience from the video streams reflecting the captured EOIs 302D′. Such tuning may relate to selection of the video chunk(s) from a video stream 214B′, and/or by deciding on the order of presenting each selected video chunks and the like.

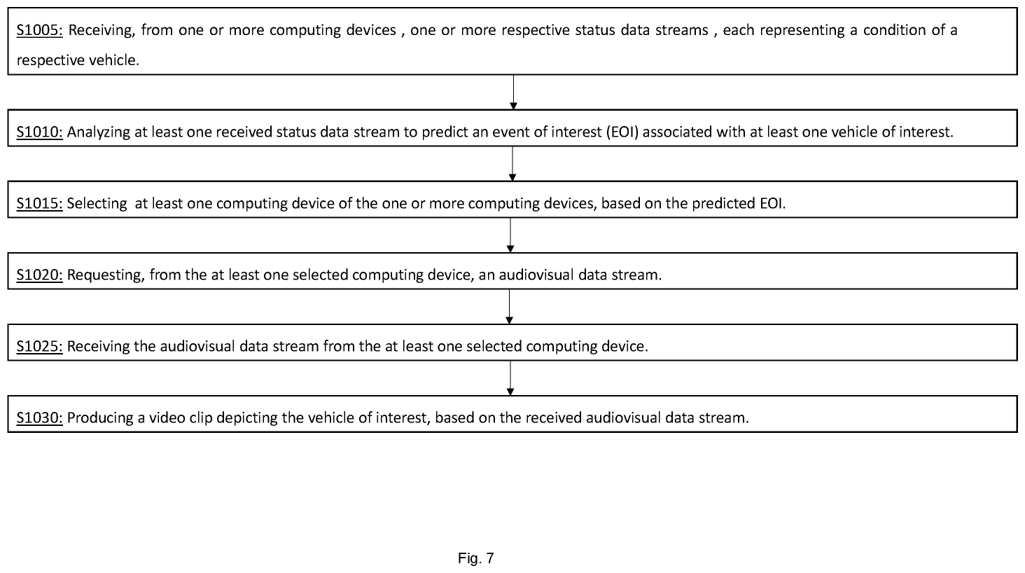

As elaborated herein, processor 1202 may be included in control system 104/MPRD unit 110, and may be configured to execute code 1204 so as to produce a video clip (e.g., video 220A of FIG. 2), as elaborated herein. Reference is made now to FIG. 7, which is a flow diagram depicting a method of automatically producing video clip 220A by at least one processor 1202, according to some embodiments of the invention.

As shown in step S1005, the at least one processor 1202 may receive, from one or more computing devices (e.g., MRUs 102 of FIG. 1), one or more respective status data streams 214A′, e.g., via communication channel 214A. The one or more status data streams 214A′ may comprise data of the first group, as elaborated herein (e.g., in relation to FIGS. 1 and 2). For example, status data streams 214A′ may include information that represents a condition of a respective vehicle (e.g., vehicle 210 of FIG. 2), such as the vehicle's momentary speed and acceleration, the vehicle's driving operations, the vehicle's engine status, etc., as elaborated herein.

As shown in step S1010, the at least one processor 1202 may collaborate with event mapper 400 of FIG. 4 (or event mapper 302D of FIG. 3), to analyze at least one of the received status data streams 214A′. Based on this analysis, event mapper 400 may predict an EOI (e.g., element 302D′ of FIG. 3) associated with at least one vehicle of interest 210. As elaborated herein, EOI 302D′ may be, or may include a data element that may represent information pertaining to a corresponding real-world event. For example, EOI 302D′ may include a tag, representing the EOI 302D′ type, a UEMI representing an identification of the specific EOI 302D′, a BTS representing a beginning time of the corresponding real-world event, an ETS representing an end time of the corresponding real-world event, and additional, EOI specific information, such as an identification of vehicles involved in the corresponding real-world event, a location of the real-world event, and the like.

For example, event mapper 400 may analyze status data streams 214A′ that may include location and speed of a first vehicle, and location and speed of a second vehicle. In an event that the first vehicle is closing-in on the second vehicle, event mapper 400 may predict an EOI 302D′, representing a real-world “overtake” event (e.g., a first vehicle of interest surpassing a second vehicle of interest) or a real-world “close-battle” event. In this example, EOI 302D′ may include an “overtake” or “close battle” tag, an identifying UEMI, a BTS, an actual or expected ETS, a location of the real-world event, and an identification of the first vehicle and second vehicle.

Additional examples of EOIs 302D′ may include: ERR, representing an event in which a driver of a vehicle of interest performs a driving error; TGL, representing meaningful Time Gain/Loss throughout the lap; OUS, representing Oversteer or Understeer events; BAM, representing accidents, crashes, wheel bumps and the like, based on status data streams 214A′ that include accelerometer data and/or GPS proximity; PIT, representing entrance to a pit stop during a session; OTZ, representing an event in which a vehicle is closing the gap from the vehicle in front, thus entering an “overtake zone”; ATK, representing an event in which a driver of a first vehicle unsuccessfully attempted to overtake (“attack”) a second vehicle; DFS, representing an event in which the leading driver performed a successful defensive maneuver; TPM, representing an event in which a vehicle is suffering a technical problem, which caused its driver to slow down or retire altogether; BST, representing an event in which a driver performed his personal best lap at this race, or at the race track 10; ATB, representing an event in which a driver performed an “all-time best” lap (e.g., for a specific category) at the track 10; RBL, representing an event in which a driver performed the best lap of the race so far; CON, representing an event in which a driver performed two or more consecutive laps with consistent, competitive lap times (e.g., within a predefined within difference in timing); DOT, representing an event of double overtake; FTL, representing an event in which a driver is a “first time leader”, e.g., leading the current race for the first time, or ever leading a race (similarly, EOI 302D′ may indicate the worst position the driver has been in); TSD, indicating a driver who has reached the fastest top speed of the race; TCS, indicating a driver who has reached the fastest corner speed (at one or more turns of race track 10); BBP, representing an event in which a driver performed the best brake (e.g., successfully decelerated their vehicle, hardest of all deceleration events); MAL, representing an event in which a vehicle of interest is experiencing a malfunction; and UXP, representing an event in which a vehicle of interest is completing a race lap at an unexpected time. Additional EOIs 302D′ may also be possible.

As shown in step S1015, the at least one processor 1202 may select at least one computing device of the one or more computing devices, based on the predicted EOI 302D′. For example, the predicted EOI 302D′ may represent a real world event involving a specific vehicle of interest 210. The at least one processor 1202 may select at least one computing device among a plurality of computing devices, that may best provide an audiovisual data stream 214C′, according to the specific properties of predicted EOI 302D′. For example, the at least one processor 1202 may select a computing device that is associated with the vehicle of interest.

Additionally, or alternatively, the at least one processor 1202 may receiving a status data stream 214A′ that may include a first indication of location, representing a location of the vehicle of interest, and may receive at least one second status data stream 214A′ that includes at least one respective indication of location, representing a location of at least one respective computing device. The at least one processor 1202 may subsequently select the at least one computing device based on the first indication of location and at least one second indication of location.

In the example of an EOI 302D′ representing a takeover event, the at least one processor 1202 may select a computing device that is located in close proximity, or may have the least estimated time-of-arrival in order to cover or portray the underlying takeover.

For example, the at least one processor 1202 may select at least one computing device such as an MRU 102 of the vehicle of interest 210; a DCT unit 12M pertaining to the vehicle of interest 210, a stationary camera 202 installed in proximity to the location (or an expected location) of vehicle of interest 210, a mobile camera 203 installed on the vehicle of interest 210, a mobile camera 203 installed on a vehicle that is in proximity to the location (or an expected location) of vehicle of interest 210, an aerial camera 204 (e.g., a camera installed on a drone) that is relevant or close (e.g., closest among a plurality of drones) to the occurrence of the real-world event represented by EOI 302D′, and the like.

As shown in step S1020, the at least one processor 1202 may request (e.g., request 214C′ of FIG. 2) from the at least one selected computing device (e.g., MRU 102, DCT 12M, 202, 203, 204) an audiovisual data stream. Pertaining to the example of the overtake EOI 30D′, the at least one processor 1202 may request 214C′ a first audiovisual data stream 214B′ from a mobile camera 203 mounted on the pursuing vehicle. Request 214C′ may include, for example, a definition of camera pan tilt and zoom in which the first audiovisual data stream 214B′ should be produced (e.g., forward, locking on the leading vehicle). In another example, the at least one processor 1202 may request 214C′ a second audiovisual data stream 214B′ from a drone-mounted camera. In this example, request 214C′ may include, for example, a definition of a location (e.g., coordinates) to where the drone should be sent, a definition of a line of sight to which the drone camera should be pointed, in order to depict the expected overtake event. Additionally, request 214C′ may include a definition of a BTS and ETS defining a timeframe in which the expected real-world event is about to take place. The at least one selected computing device (e.g., MRU 102, DCT 12M, 202, 203, 204) may produce the audiovisual data stream 214B′ (e.g., an audio stream, a video stream and/or combination thereof) according to the definitions (e.g., timeframe, location, line of sight and the like). The at least one selected computing device may transmit the produced audiovisual data stream 214B′ (e.g., as an audiovisual file, such as a Moving Pictures Expert Group (MPEG) file or any other appropriate format) to the at least one processor 1202, via computer communication channel 214B (e.g., a mobile data communication channel, a cellular data channel and the like).

As elaborated herein, the at least one processor 1202 may determine a BTS value, representing a beginning of the predicted EOI 302D′. The at least one processor 1202 may also determine an ETS value, representing an end of the predicted EOI 302D′. The determination of BTS and ETS may be performed as a rule-based decision, and may be specific to each type of EOI. Pertaining to the example of the overtake EOI, the BTS (expected beginning of the overtake) and ETS (expected end of the overtake) may be determined based on the relevant vehicles' 210 relative locations and speeds, and further based on their location on the racetrack (e.g., assuming that overtakes are less prone to occur within curves). As elaborated herein, the at least one processor 1202 may transmit the BTS value and ETS value (e.g., as part of request 214C′) to the at least one selected computing device (e.g., MRU 102, DCT 12M, 202, 203, 204) and may receive from the at least one selected computing device an audiovisual data stream 214A′ that is limited to a timeframe defined by the BTS and ETS.

As shown in step S1025, the at least one processor 1202 may receive the audiovisual data stream 214B′ from the at least one selected computing device. Pertaining to the overtake example, the received audiovisual data streams 214B′ may include: (a) a first audiovisual data stream 214B′ depicting the leading vehicle from the perspective of the pursuing vehicle at a first timeframe, and (b) a second audiovisual data stream 214B′ depicting the overtake event from the perspective of the drone, in a second timeframe.

As shown in step S1030, the at least one processor 1202 may collaborate with a video editor (e.g., video editor 226 of FIG. 2) to produce a video clip 220A depicting the event of interest and/or vehicle of interest, based on the received audiovisual data stream(s) 214B′. Pertaining to the overtake example, and as elaborated herein (e.g., in relation to FIG. 2), video editor 226 may concatenate (e.g., based on the defined timeframes), or co-present content of the first and second audiovisual data stream 214B′, to produce a video clip 220A that depicts the underlying event from multiple perspectives. Additionally, video editor 226 may produce a video clip 220A that may include, e.g., in addition to video chunks or streams 214B′, data that may be presented as part of the edited video clip. For example, central processing unit 220 may embed data of the status data stream 214A′ (e.g., engine status of a vehicle of interest, driving actions of a vehicle of interest, etc.) in video clip 220A.

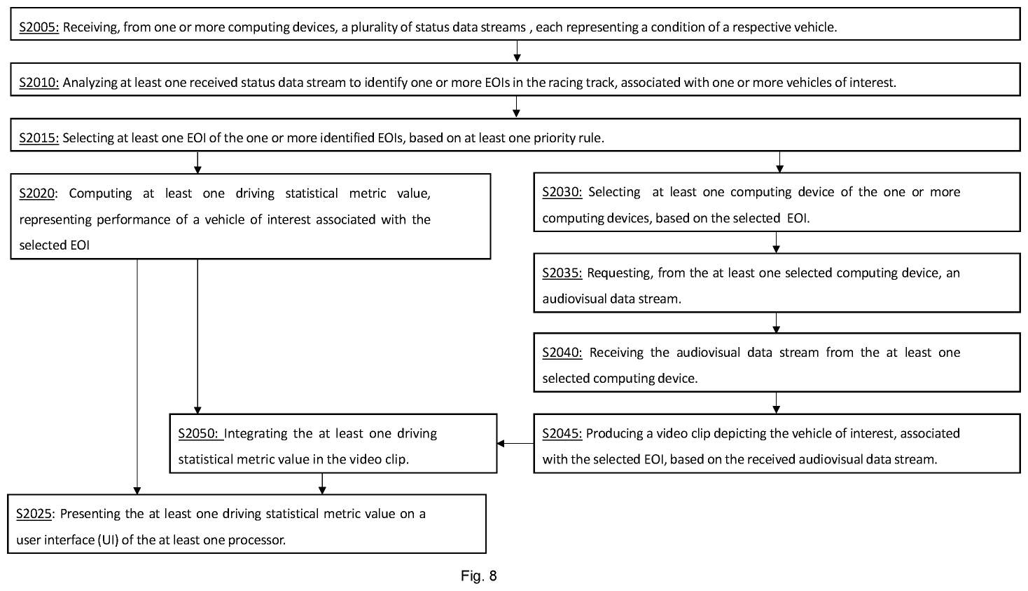

Reference is made now to FIG. 8, which is a flow diagram depicting a method of automatically prioritizing events of interest in a racing track by at least one processor 1202, according to some embodiments of the invention.

As shown in step S2005, the at least one processor 1202 may receive, from one or more computing devices (e.g., MRUs 102 of FIG. 1), one or more respective status data streams 214A′, e.g., via communication channel 214A. The one or more status data streams 214A′ may comprise data of the first group, as elaborated herein (e.g., in relation to FIG. 1, FIG. 2, and/or FIG. 7).

As shown in step S2010, the at least one processor 1202 may collaborate with event mapper 400 of FIG. 4 (or event mapper 302D of FIG. 3), to analyze at least one of the received status data streams 214A′. Based on this analysis, event mapper 400 may identify or predict an EOI (e.g., element 302D′ of FIG. 3) associated with one or more vehicles of interest 210.

As shown in step S2015, the at least one processor 1202 may collaborate with event mapper 400 of FIG. 4 to select at least one EOI of the one or more identified EOIs, based on at least one priority rule (e.g., element 408′ of FIG. 4). As elaborated herein (e.g., in relation to FIG. 4), priority rules 408′ may represent a viewer's interest according to the specific sport (e.g., in this case a racing event). For example, a priority rule 408′ may dictate that an EOI 302D′ representing an overtake at the lead of the race may be attributed a higher significance score in relation to an EOI 302D′ representing an overtake at the tail of the race. Additional priority rules 408′ may also be applied.

As elaborated herein (e.g., in relation to FIG. 4), priority rules 408′ may be implemented as a rule-base decision, based on a predefined logic, obtained (e.g., from a user) via input 1220. Additionally, or alternatively, priority rules 408′ may be implemented as machine-learning based decisions or classifications, and may be updated according to supervisory information received from a user via input 1220.

As shown in steps S2020 and S2025, the at least one processor 1202 may compute at least one vehicle condition feature value 401 (also referred to herein as status parameter value 401), representing performance of a vehicle of interest 210 associated with the selected EOI 302D′. The at least one processor 1202 may then proceed to present the at least one vehicle condition feature value 401 on a user interface (UI) of the at least one processor.

For example, the at least one vehicle condition feature value 401 may include statistics of mechanical performance metrics of the vehicle of interest, such as current data indicative of the vehicle's status (e.g., speed, rounds per minute (RPM), oil pressure, oil temperature, coolant temperature, etc.), average of such data indicative of the vehicle's status, and/or peak of such data indicative of the vehicle's engine status.

In another example, the at least one vehicle condition feature value 401 may include driving performance metrics of a driver of the vehicle of interest, in the current race, including for example the driver's current position in the race, the driver's number of break applications, the driver's lap time, and the like.

In another example, the at least one vehicle condition feature value 401 may include historical driving performance metrics of the driver or the driver's profile, including for example characteristics of the driver's performance, characteristics of the driver's stamina or endurance, characteristics of the driver's aggression (e.g., in performing steering, braking, and use of a throttle), characteristics of the driver's experience, and the like.

According to some embodiments, the at least one processor 1202 may utilize the at least one vehicle condition feature value 401 for settling bets vis-à-vis one or more users. For example, the at least one processor 1202 may receive from one or more users, via input 1220 information regarding to a bet. This bet may relate to at least one vehicle condition feature value, such as a lap-time of a specific vehicle, a position of a vehicle in the race at a specific time, and the like. The at least one processor 1202 may utilize the at least one vehicle condition feature value 401 to arbitrate or settle such bets among the one or more users.

As shown in step S2030, the at least one processor 1202 may select at least one computing device of the one or more computing devices, based on the selected EOI 302D′, as elaborated herein (e.g., in relation to FIG. 7). For example, the selected EOI 302D′ may represent a real-world event such as a vehicle malfunction, at a specific location on the racetrack. In such an event, the at least one processor 1202 may select to operate or command a computing device such as a stationary camera that is in the vicinity of the vehicle malfunction. Additionally, or alternatively, the at least one processor 1202 may select to operate or command a computing device such as a controller of a mobile camera or drone, so as to approach the location of the EOI 302D′ (e.g., the vehicle malfunction).

As shown in steps S2035 through S2045, and as elaborated herein (e.g., in relation to FIG. 7), the at least one processor 1202 may request, from the at least one selected computing device, an audiovisual data stream 214B′, and may receive the audiovisual data stream from the at least one selected computing device. The at least one processor 1202 may subsequently produce a video clip 220A depicting the vehicle of interest 210 associated with the selected EOI 320D′, based on the received audiovisual data stream.

For example, the at least one selected computing device may be a controller of a mobile unit such as an autonomous vehicle or a drone. In such embodiments, the at least one processor 1202 may request an audiovisual data stream by sending to the mobile unit (e.g., the drone) a command to shoot a scene in the racing track. The command may include one or more shooting parameters, such as a shooting location associated with the selected EOI 302D′ (e.g., coordinates of the real-world event represented by EOI 302D′). Additionally, or alternatively, the command may include a shooting direction (e.g., a line of sight, defined by pan tilt and zoom and/or field of view parameters) associated with the selected EOI (of the real-world location). Additionally, or alternatively, the command may include a BTS of the selected EOI 302D′ and/or an ETS of the selected EOI.

Additionally, or alternatively, as shown in step S2050, the at least one processor 1202 may collaborate with graphics visualizer editor 310 of FIG. 3 and/or with video editor 312 of FIG. 3 to integrate or overlay a representation of the at least one vehicle condition feature value 401 in video clip 220A, and represent the overlayed at least one driving statistical metric value on a UI (e.g., a screen) of a computing device of the at least one processor 1202, or on a UI associated with, or communicatively connected (e.g., via the Internet) with processor 1202.

Embodiments of the invention may include a practical application for automatically directing or producing audiovisual media data, and may include several improvements over currently available video editing technology.

For example, the ability of control system 104/MPRD unit 110 to learn what is shown in the video frame, its ability to automatically switch between cameras in conjunction with the way each of the cameras covers a given event, while prioritizing the events in order to assign the optimal coverage resources so as to cover the most important/interesting (or other preferences), e.g. in line with a screen policy of giving the same “screen time” for all competitors, enables the creation of an automated, AI-based show director.

In another example, control system 104/MPRD unit 110 may include an improvement over currently available media production technology by providing a comprehensive, automated, prioritized real-time coverage of a race event. The term “comprehensive” may be used in this context to indicate that all relevant occurrences in the race may be taken into consideration for production of the audiovisual media, regardless of their locations, and including relevant data pertaining to the condition of each relevant vehicle. The term “automated” and “real-time” may be used in this context to indicate that the production of the audiovisual media may be performed temporally subsequent to actual occurrence of the EOI, without human intervention, and without a time gap that may be disruptive to the viewing experience. The term “prioritized” may be used in this context to indicate that the production of the audiovisual media may include selection of the most relevant, or most interesting EOIs, e.g., based on a predefined set or list of priority. Additionally, controlling of location and/or heading of one or more cameras (e.g., 203, 204) such as cameras mounted on vehicles and/or drones by control system 104/MPRD unit 110 may facilitate these improvements without the need to deploy expensive infrastructure such as communication cables and cameras along racing track 10.

In another example, control system 104/MPRD unit 110 may be provide an improvement in computer functionality by analyzing light-weight status data (e.g., 214A′ of FIG. 2) from vehicles 210 to determine or predict an EOI, specifically requesting (e.g., request 214C′ of FIG. 2) video chunks (e.g., 214B′ of FIG. 2) from cameras (e.g., 202 associated with vehicle 210, 203 and/or 204) according to the determined EOI, and producing edited audiovisual metadata information (e.g., edited video 220A of FIG. 2), based on the determined EOI. Thus, embodiments of the invention may avoid storage, transmission, and processing of audiovisual files (e.g., from all cameras 202, 203, 204), and may produce edited video 220A from footage that is relevant to the specific EOI at hand.

Unless explicitly stated, the method embodiments described herein are not constrained to a particular order or sequence. Additionally, some of the described method embodiments or elements thereof can occur or be performed at the same point in time. Where applicable, the described method embodiments may be carried out or performed in real time.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of automatically producing a video clip by at least one processor, the method comprising:
receiving, from one or more computing devices, one or more respective status data streams, each representing a condition of a respective vehicle;
analyzing at least one received status data stream to predict an event of interest (EOI) associated with at least one vehicle of interest;
selecting at least one computing device of the one or more computing devices, based on the predicted EOI;
requesting, from the at least one selected computing device, an audiovisual data stream;
receiving the audiovisual data stream from the at least one selected computing device; and
producing a video clip depicting the vehicle of interest, based on the received audiovisual data stream.

2. The method of claim 1, wherein the at least one selected computing device is associated with the vehicle of interest.

3. The method of claim 1, further comprising:
receiving a first indication of location, representing a location of the vehicle of interest;
receiving at least one second indication of location, representing a location of at least one respective computing device; and
selecting the at least one computing device based on the first indication of location and at least one second indication of location.

4. The method of claim 1, wherein predicting an EOI comprises:
extracting at least one feature of vehicle condition from the at least one received status data stream;
inputting the at least one feature of vehicle condition to a machine-learning (ML) model, trained to output a prediction of an EOI, based on the at least one extracted input feature; and
producing a prediction of expected EOI, based on the output of the ML model.

5. The method of claim 4, wherein the ML model is trained to output a prediction of an EOI further based on a profile data element, representing a profile of a driver, and wherein the method further comprises:
receiving a profile data element, representing a profile of a driver of the vehicle of interest;
inputting the received profile data element to the ML model; and
producing the prediction of expected EOI, based on the output of the ML model.

6. The method of claim 1, wherein the predicted EOI is selected from a list consisting of: a first vehicle of interest surpassing a second vehicle of interest; a driver of a vehicle of interest performing a driving error; a vehicle of interest experiencing a malfunction; and a vehicle of interest completing a race lap at an unexpected time.

7. The method of claim 1, wherein requesting the audiovisual data stream comprises:
determining a beginning time stamp (BTS) value, representing a beginning of the predicted EOI;
determining an end time stamp (ETS) value, representing an end of the predicted EOI;
transmitting the BTS value and ETS value to the at least one selected computing device; and
receiving from the at least one selected computing device an audiovisual data stream that is limited to a timeframe defined by the BTS and ETS.

8. A method of automatically prioritizing events of interest (EOIs) in a racing track by at least one processor, the method comprising:
receiving, from one or more computing devices, a plurality of status data streams, each representing a condition of a respective vehicle;
analyzing at least one received status data stream to identify one or more EOIs in the racing track, associated with one or more vehicles of interest; and
selecting at least one EOI of the one or more identified EOIs, based on at least one priority rule.

9. The method of claim 8, further comprising:
computing at least one vehicle condition feature value, representing a condition of a vehicle of interest associated with the selected EOI; and
presenting the at least one vehicle condition feature value on a user interface (UI) of the at least one processor.

10. The method of claim 9, wherein the at least one vehicle condition feature value is selected from a list consisting of mechanical performance metrics of the vehicle of interest; driving performance metrics of a driver of the vehicle of interest, in a current race; and historical driving performance metrics of the driver.

11. The method of claim 8, further comprising:
selecting at least one computing device of the one or more computing devices, based on the selected EOI;
requesting, from the at least one selected computing device, an audiovisual data stream;
receiving the audiovisual data stream from the at least one selected computing device; and
producing a video clip depicting the vehicle of interest associated with the selected EOI, based on the received audiovisual data stream.

12. The method of claim 11, wherein the at least one selected computing device is a drone, and wherein requesting an audiovisual data stream comprises sending, to the drone, a command to shoot a scene in the racing track, said command comprising one or more shooting parameters selected from: a shooting location associated with the selected EOI, a shooting direction associated with the selected EOI, a BTS of the selected EOI and an ETS of the selected EOI.

13. The method of claim 11, further comprising:
computing at least one vehicle condition feature value, representing a condition of a vehicle of interest associated with the selected EOI; and
integrating the at least one vehicle condition feature value in the video clip.

14. The method of claim 11, further comprising:
receiving a first indication of location, representing a location of the vehicle of interest;
receiving at least one second indication of location, representing a location of at least one respective computing device,
and selecting the at least one computing device based on the first indication of location and at least one second indication of location.

15. A system for automatically producing a video clip, the system comprising: a non-transitory memory device, wherein modules of instruction code are stored, and a processor associated with the memory device, and configured to execute the modules of instruction code, whereupon execution of said modules of instruction code, the processor is configured to:
receive, from a one or more computing devices, one or more respective status data streams, each representing a condition of a respective vehicle;
analyze at least one received status data stream to predict at least one EOI associated with at least one vehicle of interest;
select at least one computing device of the one or more computing devices, based on the EOI;
request, from the at least one selected computing device, an audiovisual data stream;
receive the audiovisual data stream from the at least one selected computing device; and
produce a video clip depicting the vehicle of interest, based on the received audiovisual data stream.

16. The system of claim 15, wherein the at least one selected computing device is associated with the vehicle of interest, and wherein the processor is further configured to:
receive a first indication of location, representing a location of the vehicle of interest;
receive at least one second indication of location, representing a location of at least one respective computing device; and
select the at least one computing device based on the first indication of location and at least one second indication of location.

17. The system of claim 15, wherein the processor is configured to analyze at least one received status data stream, to predict at least one EOI by:
extracting at least one feature of vehicle condition from the at least one received status data stream;
inputting the at least one feature of vehicle condition to a machine-learning (ML) model, trained to output a prediction of an EOI, based on the at least one extracted input feature; and
producing a prediction of expected EOI, based on the output of the ML model.

18. The system of claim 17, wherein the ML model is trained to output a prediction of an EOI further based on a profile data element, representing a profile of a driver, and wherein the processor is further configured to:
receive a profile data element, representing a profile of a driver of the vehicle of interest;
input the received profile data element to the ML model; and
produce the prediction of expected EOI, based on the output of the ML model.

19. The system of claim 15, wherein the predicted EOI is selected from a list consisting of: a first vehicle of interest surpassing a second vehicle of interest; a driver of a vehicle of interest performing a driving error; a vehicle of interest experiencing a malfunction; and a vehicle of interest completing a race lap at an unexpected time.

20. The system of claim 15, wherein the processor is further configured to request the audiovisual data stream by:
determining a beginning time stamp (BTS) value, representing a beginning of the predicted EOI;
determining an end time stamp (ETS) value, representing an end of the predicted EOI;
transmitting the BTS value and ETS value to the at least one selected computing device; and
receiving from the at least one selected computing device an audiovisual data stream that is limited to a timeframe defined by the BTS and ETS.
